(19) United States
(12) Patent Application Publication
(10) Pub. No.: US 2024/0221120 A1
(43) Pub. Date: Jul. 4, 2024

(54) VIDEO SYNTHESIS APPARATUS, VIDEO SYNTHESIS METHOD, AND PROGRAM

(71) Applicant: NIPPON TELEGRAPH AND TELEPHONE CORPORATION, Tokyo (JP)

(72) Inventors: Shoichiro TAKEDA, Tokyo (JP); Kenta NIWA, Tokyo (JP); Shinya SHIMIZU, Tokyo (JP); Susumu YAMAMOTO, Tokyo (JP)

(73) Assignee: NIPPON TELEGRAPH AND TELEPHONE CORPORATION, Tokyo (JP)

(21) Appl. No.: 18/558,094

(22) PCT Filed: May 13, 2021
(86) PCT No.: PCT/JP2021/018210

§ 371 Date: Oct. 30, 2023

(51) Int. Cl. G06T 5/20; G06T 5/10; H04N 9/64

(52) U.S. Cl. CPC G06T 5/20; G06T 5/10; H04N 9/646; G06T 2207/10016; G06T 2207/10024; G06T 2207/20056

(57) ABSTRACT

Implementation of video enhancement processing is facilitated. A video input unit (11) extracts a color signal from a target video signal. A signal converter (12) extracts a target color signal corresponding to a desired color change from the color signal. A filter processor (13) generates an enhanced minute color signal which enhances a desired color change included in the target color signal by applying a weighted enhancement time-frequency band-pass filter to the target color signal to a target color signal. An addition unit (14) generates an enhanced target color signal by adding the enhanced minute color signal to the target color signal. A video synthesizing unit (15) adds the enhancement target color signal and the color signals other than the target color signal to synthesize an enhanced video in which a desired color change included in the target video signal is enhanced.

### TECHNICAL FIELD

The present invention relates to a video enhancement technique for enhancing a minute change in a video.

### BACKGROUND ART

Video magnification is a video enhancement technique which detects only a desired minute change (color change or motion) from an input video and enhances and visualizes the detected minute change (for example, refer to NPLs 1 to 3). If video magnification is applied, for example, it is possible to input a video of a seemingly motionless human face and synthesize a video enhancing minute undulations of blood vessels due to pulsation, changes in facial color, and the like. Video magnification is composed of multi-step processing composed of (1) time frequency band-pass filtering, (2) weighted enhancement filtering, and (3) addition processing. (1) In time-frequency band-pass filtering, a time-series signal representing minute changes in an arbitrary time-frequency band is detected from a video signal. (2) In the weighted enhancement filtering process, an enhanced minute signal is generated by enhancing only minute components from the obtained time-series signal. (3) In addition processing, the enhanced minute signal is added to the original video signal. Video magnification can obtain a visualized video by enhancing only minute changes in the input video by performing these multi-stage processes.

### CITATION LIST

### Non Patent Literature

[NPL 1] Yichao Zhang, Silvia L. Pintea, and Jan C. van Gemert, “Video Acceleration Magnification,” IEEE International Conference on Computer Vision and Pattern Recognition, 2017.
[NPL 2] Shoichiro Takeda, Kazuki Okami, Dan Mikami, Megumi Isogai, Hideaki Kimata, “Jerk-Aware Video Acceleration Magnification,” IEEE International Conference on Computer Vision and Pattern Recognition, 2018.
[NPL 3] Xiu Wu, Xuezhi Yang, Jing Jin, Zhao Yang, “Amplitude-Based Filtering for Video Magnification in Presence of Large Motion,” IEEE International Conference on Computer Vision and Pattern Recognition, 2018.

### SUMMARY OF INVENTION

### Technical Problem

However, NPLs 1 to 3 use multi-step processing as described above, which leads to complexity of an algorithm. Algorithm complexity leads to reduced algorithm readability, implementation difficulty, and increased computational complexity. In addition, since the operation and effects of Video Magnification are difficult to understand, it is difficult for users to predict or interpret the behavior and results of applying the algorithm. Furthermore, the performance of each process itself is also insufficient and there is also the problem that minute changes which are not intended by a user are enhanced and artifacts (noise) are generated during the enhancement.

An object of the present invention is to facilitate implementation of video enhancement processing which enhances a minute change in a video in view of the above technical problems.

### Solution to Problem

A video synthesizing device according to a first aspect of the present invention includes: a signal conversion unit configured to extract a color signal of a predetermined resolution from an input video; a filtering unit configured to generate an enhanced minute color signal in which a minute color change included in the color signal is enhanced by applying a weighted enhanced time-frequency band-pass filter to the color signal; and a video synthesizing unit configured to synthesize an enhanced video in which the minute color change in the input video is enhanced by using the color signal and the enhanced minute color signal.

A video synthesizing device according to a second aspect of the present invention includes: a signal conversion unit configured to extract a phase signal corresponding to a desired change in motion from an input video; a filter processing unit configured to generate an enhanced minute phase signal which enhances a minute phase change included in the phase signal by applying a self-addition weighted enhancement time-frequency band-pass filter to the phase signal; and a video synthesizing unit configured to synthesize an enhanced video in which minute motion changes in the input video are enhanced using the phase signal and the enhanced minute phase signal.

### Advantageous Effects of Invention

The present invention integrates a plurality of processes performed in multiple stages in the related art into one filtering process. Therefore, according to the present invention, it is possible to easily implement video enhancement processing for enhancing a minute change in a video.

### BRIEF DESCRIPTION OF DRAWINGS

FIG. 1 is a diagram illustrating a functional configuration of a video synthesizing device according to a first embodiment.

FIG. 2 is a diagram illustrating a processing procedure of a video synthesizing method according to the first embodiment.

FIG. 3 is a diagram illustrating a functional configuration of a video synthesizing device according to a second embodiment.

FIG. 4 is a diagram illustrating a processing procedure of a video synthesizing method according to the second embodiment.

FIG. 5 is a diagram illustrating a functional configuration of a computer.

### DESCRIPTION OF EMBODIMENTS

An embodiment of the invention will be described in detail below. Note that, in the drawings, constituent parts having the same functions will be denoted by the same numbers and redundant explanations will be omitted.

Note that, although symbols such as “\hat{ }” used in the text need to be written directly above the character immediately following it, they are written immediately before the character in question due to text notation limitations. In the mathematical expressions, these symbols are written in their original positions, that is, directly above the letters.

### First Embodiment

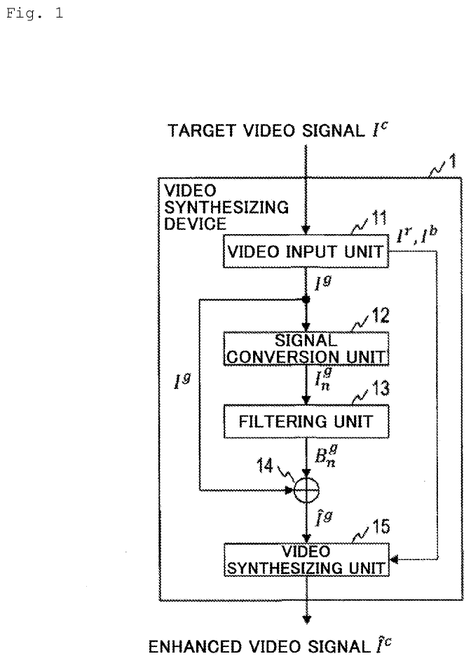

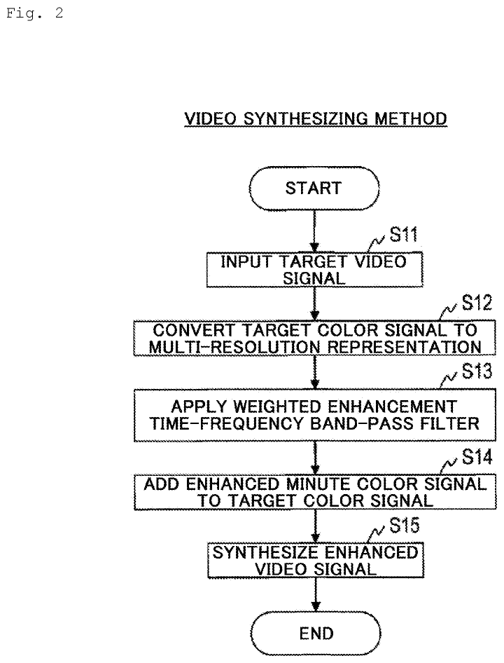

A first embodiment of the present invention is a video synthesizing device and a method for detecting a minute color change in an arbitrary time-frequency band in a video and synthesizing a video enhancing the detected minute color change. As shown in FIG. 1, a video synthesizing device 1 of the first embodiment has a target video signal as an input and outputs an enhanced video signal which enhances a minute color change in the target video signal. The video synthesizing device 1 includes a video input unit 11, a signal conversion unit 12, a filtering unit 13, an addition unit 14, and a video synthesizing unit 15. The video synthesizing method of the first embodiment is realized by the video synthesizing device 1 which performs the processing of each step shown in FIG. 2.

A video synthesizing device is, for example, a special device configured by reading a special program into a publicly known or dedicated computer having a central processing unit (CPU), a main storage device (random access memory: RAM), and the like. The video synthesizing device performs each process under the control of, for example, a central processing unit. Data input to the video synthesizing device and data obtained in each process are stored in, for example, a main storage device and data stored in the main storage device is read out to the central processing unit as needed and used for other processes. At least a part of each processing unit included in the video synthesizing device may be configured by hardware such as an integrated circuit.

A video synthesizing method performed by the video synthesizing device 1 of the first embodiment will be described below with reference to FIG. 2.

A target video signal is input to the video synthesizing device 1. The target video signal is, for example, a digital video signal such as an RGB signal or a YIQ signal. In the embodiment, it is assumed that the target video signal is an RGB signal and is expressed by Expression (1).

$$\begin{matrix}[ Math . 1 ] & \\ {I}^{c} ( x , y , t ) , c ∈ \{ r , g , b \} & ( 1 )\end{matrix}$$

Here, (x,y) represents a pixel position and t represents a time frame index. A target video signal I^{c}(x, y, t) input to the video synthesizing device 1 is input to the video input unit 11.

In Step S11, the video input unit 11 selects one or more color signals corresponding to a minute color change to be enhanced from the input target video signal I^{c} (x, y, t). In the following description, assuming that a color signal corresponding to green is selected (that is, c=g), the selected color signal (hereinafter also referred to as a “target color signal”) is denoted by I^{g} (x, y, t). When selecting a color signal corresponding to red, the target color signal should be read as I^{r} (x, y, t). Similarly, when selecting a color signal corresponding to blue, the target color signal should be read as I^{b} (x, y, t). The video input unit 11 outputs the target color signal I^{g} (x, y, t) to the signal conversion unit 12 and the addition unit 14 and outputs the color signal I^{r} (x, y, t) and I^{b} (x, y, t) other than the target color signal I^{g} (x, y, t) to the video synthesizing unit 15.

In Step S12, the signal conversion unit 12 receives the target color signal I^{g} (x, y, t) from the video input unit 11 and converts the target color signal I^{g} (x, y, t) into multi-resolution representation. For example, it may be converted to a multi-resolution representation called a Gaussian pyramid defined by Expression (2).

$$\begin{matrix}[ Math . 2 ] & \\ \{ {I}_{n}^{g} ( x , y , t ) \vert n = 1 , … , N \} & ( 2 )\end{matrix}$$

Here, N represents the resolution number and n represents the resolution index.

The signal conversion unit 12 selects a color signal Ing (x, y, t) with a predetermined resolution n from the target color signal {Iₙ^{g} (x, y, t)| n=1, . . . , N} converted to a multi-resolution representation. The signal conversion unit 12 outputs the target color signal Iₙ^{g} (x, y, t) of the selected resolution n to the filtering unit 13.

In Step S13, the filtering unit 13 receives the target color signal Iₙ^{g} (x, y, t) of resolution n from the signal conversion unit 12 and applies weighted enhancement time-frequency band-pass filtering to the target color signal Iₙ^{g} (x, y, t) of resolution n on the basis of a predetermined enhancement rate α∈R and a time frequency fₜ∈R arbitrarily selected by a user, as shown in Expression (3).

$$\begin{matrix}[ Math . 3 ] & \\ {B}_{n}^{g} ( x , y , t ) = {\sum }_{k = - K}^{K} A ( d ; ε ) sLo G ( k ; σ ) \cdot {I}_{n}^{g} ( x , y , t - k ) & ( 3 )\end{matrix}$$

Here, Bₙ^{g} (x, y, t) represents an enhanced minute color signal obtained by enhancing only the minute color signal at the time frequency fₜ with the enhancement rate α. k∈[−K, K] represents the range for filtering. That is to say, a window width for filtering is 2K+1. Parameters d, ε, and σ will be described later. The filtering unit 13 outputs the generated enhanced minute color signal Bₙ^{g} (x, y, t) to the addition unit 14.

The processing of the filtering unit 13 will be described in more detail below. In Expression (3), the part which implements the time-frequency band-pass filtering is sLOG (k; σ). Furthermore, A(d; ε) is the part which implements the weighted enhancement filtering process. The steps will be described in order below.

### <<Time-Frequency Band-pass Filtering>>

The role of sLOG (k; σ) in Expression (3) will be explained. First, LoG (k; σ) is a filter called LOG (Laplacian of Gaussian). The LOG filter is defined in the form of the second derivative of the Gaussian function as shown in Expression (4).

$$\begin{matrix}[ Math . 4 ] & \\ L o G ( k ; σ ) = - \frac{1}{\sqrt{2 π} σ} \frac{{k}^{2} - {σ}^{2}}{{σ}^{4}} exp ( - \frac{{k}^{2}}{2 {σ}^{2}} ) & ( 4 )\end{matrix}$$

Time-frequency band-pass filtering can be performed by convolving the LOG filter with the color signal. Here, the problem is how to choose the optimum window width 2K+1 and the parameter σ of LOG (k; σ). In NPLs 1 and 2, the window width 2K+1=fs/4 fₜ and the parameter σ=fs/4(2)^{1/2}ft of LOG (k; σ) used in the field of video matching are adopted. However, from the viewpoint of time-frequency band-pass filtering, the window width 2 K+1 and the parameter σ are not suitable, and thus the time-frequency selectivity is poor. Therefore, in this embodiment, it is considered to set the optimal window width 2K+1 and parameter σ for time-frequency band-pass filtering.

First, a method for setting the optimum window width 2K+1 will be described. Assuming that the sampling frequency of the target video signal is fₛ, the frequency resolution Δf of LOG (k; σ) satisfies Expression (5) from a time-frequency trade-off relationship.

$$\begin{matrix}[ Math . 5 ] & \\ Δ f = \frac{{f}_{s}}{2 K + 1} & ( 5 )\end{matrix}$$

That is to say, it can be seen that increasing the window width improves the frequency resolution of LOG (k; σ). However, the larger the window width, the higher the calculation cost. Therefore, in the present invention, the window width is adaptively set as shown in Expression (6).

$$\begin{matrix}[ Math . 6 ] & \\ 2 K + 1 = \frac{2 {f}_{s}}{{f}_{t}} ⇔ Δ f = \frac{{f}_{t}}{2} & ( 6 )\end{matrix}$$

As a result, the frequency bins of LOG (k; σ) are set as in Expression (7).

$$[ Math . 7 ]$$

$$\{ f = m Δ f = \frac{{mf}_{t}}{2} \vert m = 0 , … , 2 K \} \qquad ( 7 )$$

By configuring in this way, a direct current (DC) component is assigned to f=0 and all frequency band components lower than f=fₜ other than the DC component are assigned to f=fₜ/2. Therefore, the DC component can be clearly separated and considered and the minimum ideal frequency resolution can be obtained.

Subsequently, a method for setting the optimum parameter σ will be described. From the point of view of time-frequency band-pass filtering, it is desirable that LOG (k; σ) has a maximum frequency response at time-frequency fₜ. Therefore, in this embodiment, the optimum parameter σ is obtained by solving the optimization problem of Expression (8).

[Math. 8]

fₜ=argmax_{f>0}F_{2K+1}[LoG(k;σ)](f) (8)

Here, F₂ₓ₊₁ [·] (f) represents the one-dimensional Fourier transform. The optimization problem of Expression (8) can be solved in closed form as in Expression (9).

$$[ Math . 9 ]$$

$$\frac{\partial }{\partial f} {F}_{2 K + 1} [ LoG ( k ; σ ) ] ( {f}_{t} ) = 0 ⇔ σ = \frac{\sqrt{2}}{2 π {f}_{t}} \qquad ( 9 )$$

The optimal parameter σ determined above allows LOG (k; σ) to have the maximum frequency response at the time frequency fₜ.

LOG (k; σ) has the maximum frequency response at the time frequency fₜ and normalizes a value thereof to 1 so that, when the enhancement factor α is applied, small color changes are purely multiplied by α, making it easier to control the degree of enhancement. Therefore, sLOG (k; σ) obtained by scaling LOG (k; σ) is defined as in Expression (10).

$$[ Math . 10 ]$$

$$s LoG ( k ; σ ) = \frac{LoG ( k ; σ )}{\vert {F}_{2 K + 1} [ LoG ( k ; σ ) ] ( {f}_{t} ) \vert} \qquad ( 10 )$$

### <<Weighted Enhancement Filtering>>

The role of A(d; ε) in Expression (3) will be explained. First, A(d; ε) is defined as in Expressions (11) to (13).

$$[ Math . 11 ]$$

$$A ( d ; ε ) = ( α - 1 ) exp ( - \frac{{d}^{2}}{2 {σ}_{a}^{2}} ) \qquad ( 11 )$$

$$d = {I}_{n}^{c} ( x , y , t ) - \frac{1}{2 K + 1} {\sum }_{k = - K}^{K} {I}_{n}^{c} ( x , y , t - k ) \qquad ( 12 )$$

$$\sqrt{2 ln 2} {σ}_{a} = ε \qquad ( 13 )$$

As shown in Expressions (11) to (13), A(d; ε) weights the enhancement rate α on the basis of a variation d of the color signal Iₙ^{c} (x, y, t) and is necessary to enhance only minute color changes. Here, (2ln2)^{1/2}σₐ=ε indicates the half width at half maximum, and when d=ε is satisfied, the enhancement rate is designed to be exactly half, A(d; ε)=(α−1)/2. By configuring in this manner, if the variation amount d of the color signal is too large than a on the basis of the value ε of the color signal selected by the user, the enhancement rate becomes 0, making it possible to enhance only minute color signals.

Finally, when the filter processing of Expression (3) is performed on the basis of Expressions (10) to (13), it is possible to obtain an enhanced minute color signal Bₙ^{g} (x, y, t) in which only the minute color signal at the time frequency fₜ is enhanced with the enhancement rate α.

In Step S14, the addition unit 14 receives the target color signal I^{g} (x, y, t) from the video input unit 11 and the enhanced minute color signal Bₙ^{g} (x, y, t) from the filtering unit 13 and generates an enhancement target color signal \hat{ }I^{g}(x, y, t) obtained by adding signal B^{g}(x, y, t) obtained by up-sampling enhancement minute color signal Bₙ^{g}(x, y, t) to the original resolution to target color signal I^{g}(x, y, t). The addition unit 14 outputs the generated enhancement target color signal \hat{ }I^{g}(x, y, t) to the video synthesizing unit 15.

In Step S15, the video synthesizing unit 15 receives the enhancement target color signal \hat{ }I^{g}(x, y, t) from the addition unit 14 and color signals I^{r}(x, y, t) and I^{b}(x, y, t) other than the target color signal I^{g}(x, y, t) from the video input unit 11 and synthesizes these signals \hat{ }I^{g}(x, y, t), I^{r}(x, y, t) and I^{b}(x, y, t) to generate an enhanced video signal \hat{ }I^{c}(x, y, t). The video synthesizing unit 15 outputs the generated enhanced video signal \hat{ }I^{c}(x, y, t) to the video synthesizing device 1.

### Second Embodiment

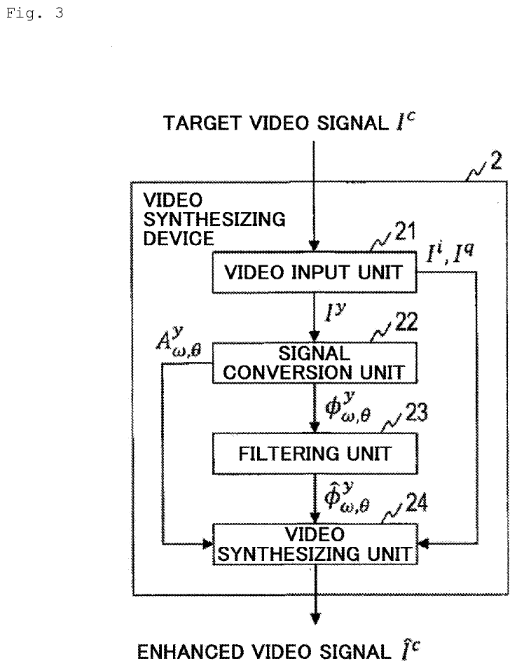

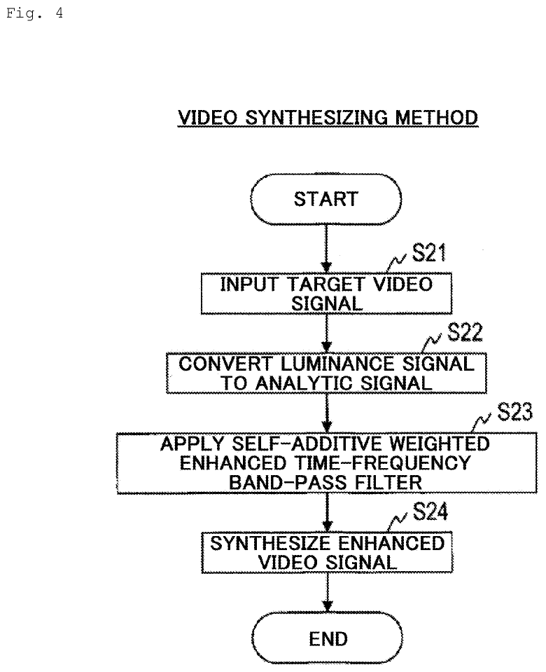

A second embodiment of the present invention is a video synthesizing device which detects a minute movement in an arbitrary time-frequency band in a video and synthesizes a video which enhances the detected minute movement and a method therefor. As shown in FIG. 3, the video synthesizing device 2 of the second embodiment has a target video signal as an input and outputs an enhanced video signal which enhances a minute movement in the target video signal. The video synthesizing device 2 includes a video input unit 21, a signal conversion unit 22, a filtering unit 23, and a video synthesizing unit 24. The video synthesizing method of the second embodiment is realized by the video synthesizing device 2 configured to perform the processing of each step shown in FIG. 4.

The video synthesizing method performed by the video synthesizing device 2 of the second embodiment will be described below with reference to FIG. 4.

A target video signal is input to the video synthesizing device 2. In this embodiment, it is assumed that the target video signal is the YIQ signal and is represented by Expression (14).

$$[ Math . 12 ]$$

$${I}^{c} ( x , y , t ) , c ∈ \{ y , i , q \} \qquad ( 14 )$$

Here, (x,y) represents the pixel position and t represents the time frame index. The target video signal I^{c}(x, y, t) input to the video synthesizing device 2 is input to the video input unit 21.

In Step S21, the video input unit 21 selects a luminance signal I^{y}(x, y, t) from the input target video signal I^{c}(x, y, t). The video input unit 21 outputs the luminance signal I^{y}(x, y, t) to the signal conversion unit 22 and converts signals Iⁱ(x, y, t) and I^{q}(x, y, t) other than luminance signal I^{y}(x, y, t) are output to the video synthesizing unit 24.

In Step S22, the signal conversion unit 22 receives the luminance signal I^{y}(x, y, t) from the video input unit 21 and converts the luminance signal I^{y}(x, y, t) into a plurality of band frequencies ω∈Ω and an analytic signal in a plurality of directions θ∈Θ. This analytic signal is represented by Expression (15).

$$[ Math . 13 ]$$

$$\{ {R}_{ω , θ}^{y} ( x , y , t ) \vert ω ∈ Ω , θ ∈ Θ \} \qquad ( 15 )$$

Here, an analytic signal with a certain frequency ω and a certain direction θ is given by Expression (16).

$$[ Math . 14 ]$$

$$\begin{matrix}{R}_{ω , θ}^{y} ( x , y , t ) = {A}_{ω , θ}^{y} ( x , y , t ) exp ( i {ϕ}_{ω , θ}^{y} ( x , y , t ) ) \\ = {ψ}_{ω , θ} ( x , y ) * {I}^{y} ( x , y , t )\end{matrix} \qquad ( 16 )$$

Here, R_{ω,θ}_{^{y}}(x, y, t) represents an analytic signal, A_{ω,θ}_{^{y}}(x, y, t) represents an amplitude signal, and ϕ_{ω,θ}_{^{y}}(x, y, t) represents a phase signal. ψ_{ω,θ} (x,y) is a filter group called a complex steerable filter (CSF). Note that the method for transforming the analytic signal is not limited to the above. For example, transform using the Riesz Transform may be used.

The signal conversion unit 22 selects a phase signal φ_{ω,θ}_{^{y}} (x, y, t) representing local motion in the video from the analytic signal {R_{ω,θ}_{^{y}} (x, y, t)|ω∈Ω, θ∈Θ}. The signal conversion unit 22 outputs the selected phase signal φ_{ω,θ}_{^{y}} (x, y, t) to the filtering unit 23 and outputs the amplitude signal A_{ω,θ}_{^{y}} (x, y, t) to the video synthesizing unit 24.

In Step S23, the filtering unit 23 receives the phase signals φ_{ω,θ}_{^{y}} (x, y, t) from the signal conversion unit 22 and applies self-addition weighted enhancement time-frequency band-pass filtering to the phase signals φ_{ω,θ}_{^{y}} (x, y, t) on the basis of a predetermined enhancement rate α∈R and time frequency fₜ∈R arbitrarily selected by the user, as shown in Expression (17).

$$[ Math . 15 ]$$

$${\hat{ϕ}}_{ω , θ}^{y} ( x , y , t ) = {\sum }_{k = - K}^{K} ( A ( d ; ε ) s LoG ( k ; σ ) + δ ( k ) ) \cdot {ϕ}_{ω , θ}^{y} ( x , y , t - k ) \qquad ( 17 )$$

Here, \hat{ }φ_{ω,θ}_{^{y}} (x, y, t) is the output of the filtering unit 23 and represents an enhanced phase signal obtained by adding a signal obtained by enhancing only a minute phase signal at the time frequency fₜ with an enhancement rate a to the original phase signal. sLOG (k; σ) in Expression (17) is Expression (10). A(d; ε) in Expression (17) is defined as Expressions (18) to (20) in the case of phase signals.

$$[ Math . 16 ]$$

$$A ( d ; ε ) = ( α - 1 ) exp ( - \frac{{d}^{2}}{2 {σ}_{a}^{2}} ) \qquad ( 18 )$$

$$d = {ϕ}_{ω , θ}^{y} ( x , y , t ) - \frac{1}{2 K + 1} {\sum }_{k = - K}^{K} {ϕ}_{ω , θ}^{y} ( x , y , t - k ) \qquad ( 19 )$$

$$\sqrt{2 ln 2} {σ}_{a} = εω \qquad ( 20 )$$

Here, (2ln2)^{1/2}σₐ=εω is derived from the Fourier transform shift theorem and converts a user-selected local motion ε into a phase signal εω at frequency ω. By configuring in this way, when the variation d of the phase signal is too large than εω on the basis of the local motion ε selected by the user, the enhancement rate becomes 0 and only the minute phase signal can be enhanced.

Also, δ(k) is defined by Expression (21).

$$[ Math . 17 ]$$

$$δ ( k ) = \{ \begin{matrix}1 , & k = 0 , \\ 0 , & otherwise\end{matrix} . \qquad ( 21 )$$

This allows the phase signals φ_{ω,θ}_{^{y}} (x, y, t) to pass through as they are. As a result, Expression (17) can be rewritten as Expression (22).

$$[ Math . 18 ]$$

$${\hat{ϕ}}_{ω , θ}^{y} ( x , y , t ) = {ϕ}_{ω , θ}^{y} ( x , y , t ) + {\sum }_{k = - K}^{K} A ( d ; ε ) s LoG ( k ; σ ) \cdot {ϕ}_{ω , θ}^{y} ( x , y , t - k ) \qquad ( 22 )$$

That is to say, the procedure of adding the result of weighted enhancement filtering by A (d; ε) sLOG (k; σ) to the original phase signal φ_{ω,θ}_{^{y}} (x, y, t) is integrated into one filtering process using δ(k). Thus, the need to store the original phase signals φ_{ω,θ}_{^{y}} (x, y, t) in a memory is eliminated and direct conversion from the phase signal φ_{ω,θ}_{^{y}} (x, y, t) to the enhanced phase signal \hat{ }φ_{ω,θ}_{^{y}} (x, y, t) becomes possible while reducing the memory usage associated with this by a factor of 2.

In Step S24, the video synthesizing unit 24 receives the amplitude signal A_{ω,θ}_{^{y}} (x, y, t) from the signal conversion unit 22 and the enhanced phase signal \hat{ }φ_{ω,θ}_{^{y}} (x, y, t) from the filtering unit 23 and an enhanced analytic signal \hat{ }R_{ω,θ}_{^{y}} (x, y, t) in which minute motions are enhanced is generated by Expressions (23) to (24).

$$[ Math . 19 ]$$

$$\{ {\hat{R}}_{ω , θ}^{y} ( x , y , t ) \vert ω ∈ Ω , θ ∈ Θ \} \qquad ( 23 )$$

$${\hat{R}}_{ω , θ}^{y} ( x , y , t ) = {A}_{ω , θ}^{y} ( x , y , t ) exp ( i {\hat{ϕ}}_{ω , θ}^{y} ( x , y , t ) ) \qquad ( 24 )$$

Subsequently, the video synthesizing unit 24 generates an enhanced luminance signal \hat{ }I^{y} (x, y, t) in which only minute movements are enhanced from the set of enhanced analysis signals \hat{ }R_{ω,θ}_{^{y}} (x, y, t). Also, the video synthesizing unit 24 receives signals Iⁱ (x, y, t) and I^{q} (x, y, t) other than the luminance signal I^{y} (x, y, t) from the video input unit 21 and synthesizes the enhanced luminance signal \hat{ }I^{y} (x, y, t) with the signals Iⁱ (x, y, t) and I^{q} (x, y, t) to generate the enhanced video signal \hat{ }I^{c}(x, y, t). The video synthesizing unit 24 outputs the generated enhanced video signal \hat{ }I^{c} (x, y, t) to the video synthesizing device 2.

### Effects of Invention

The present invention simplifies a video enhancement processing algorithm for enhancing a minute change in a video. Specifically, the multi-stage processing performed in Video Magnification in the related art has been integrated into a single filtering process. This made the algorithm more readable and easier to implement. In addition, the performance of Video Magnification itself is improved by reviewing each process included in the conventional multi-step process while integrating it into a single filter process, it is possible to enhance the minute color changes and movements that users expect, and the occurrence of artifacts that occur during enhancement is reduced. Furthermore, when enhancing minute movements, memory usage can be saved at the same time.

Although the embodiments of the present invention have been described above, the specific configuration is not limited to these embodiments and it is needless to say that the present invention includes any appropriate design changes without departing from the gist of the present invention. The various processes described in the embodiments are not only performed in chronological order in accordance with the described order, but may also be performed in parallel or individually according to the processing capacity of the device that performs the processes or as necessary.

### [Program and Recording Medium]

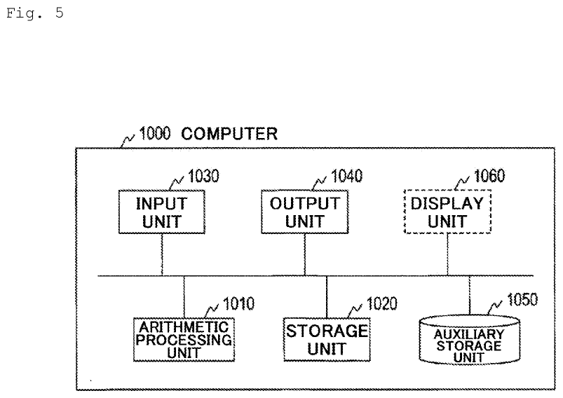

When the various processing functions of each device described in the above embodiments are realized by a computer, the processing contents of the functions that each device needs to have are described by a program. Furthermore, various processing functions in each of the devices described above are realized on the computer by operating the arithmetic processing unit 1010, the input unit 1030, the output unit 1040, and the like by loading this program into the storage unit 1020 of the computer shown in FIG. 5.

A program describing the contents of this processing can be recorded in a computer-readable recording medium. Computer-readable recording media are, for example, non-temporary recording media such as magnetic recording devices and optical discs.

Also, distribution of this program is, for example, executed by selling, assigning, lending, and the like portable recording media such as DVDs and CD-ROMs on which the program is recorded. In addition, the program may be distributed by storing the program in the storage device of the server computer and transferring the program from the server computer to other computers via the network.

A computer which executes such a program, for example, first stores a program recorded on a portable recording medium or a program transferred from a server computer once in the auxiliary recording unit 1050, which is a own non-temporary storage device thereof. Furthermore, when performing the process, this computer reads the program stored in the auxiliary recording unit 1050, which is an own non-temporary storage device thereof, into the storage unit 1020, which is a temporary storage device and performs processing which follows the read program. In addition, as another execution form of this program, the computer may read the program directly from a portable recording medium and perform processing according to the program, and each time the program is transferred from the server computer to this computer, may sequentially execute processing according to the received program. Moreover, a configuration for performing the above-described processing may be employed by a so-called an Application Service Provider (ASP) type service, which does not transfer the program from the server computer to this computer and realizes the processing function only by an execution instruction and result acquisition thereof. Note that the program in this embodiment includes information to be used for processing by a computer and equivalent to a program (such as data that is not a direct command to a computer but has the property of prescribing computer processing).

Moreover, in this embodiment, the device is configured by executing a predetermined program on a computer, but at least a part of these processing contents may be implemented by hardware.

1. A video synthesizing device comprising a processor configured to execute operations comprising:
extracting a color signal of a predetermined resolution from an input video;
generating an enhanced minute color signal, wherein the enhanced minute color signal is based on enhancing the color signal with a minute color change by applying a weighted enhanced time-frequency band-pass filter to the color signal; and
synthesizing an enhanced video in which the minute color change in the input video is enhanced by using the color signal and the enhanced minute color signal.

2. The video synthesizing device according to claim 1, wherein
the weighted enhanced time-frequency band-pass filter includes an enhanced function A which weights a predetermined enhanced rate α on the basis of a variation amount d of the color signal and a Laplacian of Gaussian (LoG) filter which maximizes a frequency response at a predetermined time frequency f.

3. The video synthesizing device according to claim 2, wherein
the weighted enhancement time-frequency band-pass filter has a window width of 2K+1, k∈[−K, K], a value of the color signal of ε, a parameter of the Laplacian of Gaussian (LoG) filter of σ, (2ln2)^{1/2}σ_{α}=ε, and F_{2K+1}[·] as a one-dimensional Fourier transform and is defined by the following Expression:
$$[ Math . 20 ]$$
$$A ( d ; ε ) s LoG ( k ; σ ) , \\ s LoG ( k ; σ ) = \frac{LoG ( k ; σ )}{\vert {F}_{2 K + 1} [ LoG ( k ; σ ) ] ( {f}_{t} ) \vert} , \\ A ( d ; ε ) = ( α - 1 ) exp ( - \frac{{d}^{2}}{2 {σ}_{a}^{2}} ) .$$

4. A video synthesizing device, comprising:
extracting a phase signal corresponding to a desired change in motion from an input video;
generating an enhanced minute phase signal, wherein the enhanced minute phase signal is based on enhancing a minute phase change included in the phase signal by applying a self-addition weighted enhancement time-frequency band-pass filter to the phase signal; and
synthesizing an enhanced video in which minute motion changes in the input video are enhanced using the phase signal and the enhanced minute phase signal.

5. The video synthesizing device according to claim 4, wherein
the self-addition weighted enhancement time-frequency band-pass filter has a window width of 2K+1, k∈[−K, K], a value of the phase signal of a frequency ω of εω, a parameter of a Laplacian of Gaussian (LoG) filter of σ, (2ln2)^{1/2}σ_{α}=εω, and F_{2K+1}[·] as a one-dimensional Fourier transform and is defined by the following Expression:
$$[ Math . 21 ]$$
$$A ( d ; ε ) s LoG ( k ; σ ) + δ ( k ) , \\ s LoG ( k ; σ ) = \frac{LoG ( k ; σ )}{\vert {F}_{2 K + 1} [ LoG ( k ; σ ) ] ( {f}_{t} ) \vert} , \\ A ( d ; ε ) = ( α - 1 ) exp ( - \frac{{d}^{2}}{2 {σ}_{a}^{2}} ) , \\ δ ( k ) = \{ \begin{matrix}1 , & k = 0 , \\ 0 , & otherwise\end{matrix} .$$

6. A video synthesizing method, comprising:
extracting a color signal having a predetermined solution from an input video;
generating an enhanced minute color signal which enhances a minute color change included in the color signal by applying a weighted enhancement time-frequency band-pass filter to the color signal; and
synthesizing an enhanced video in which the minute color change in the input video is enhanced using the color signal and the enhanced minute color signal.

7-8. (canceled)

9. The video synthesizing device according to claim 1, wherein the input video includes video data based on an RGB (Red-Green-Blue) signal.

10. The video synthesizing device according to claim 1, wherein the self-addition weighted enhancement time-frequency band-pass filter includes an enhancement rate of zero when a variation amount of the color signal is at least at a predetermined maximum variation amount to enhance the minute color change included in the color change.

11. The video synthesizing device according to claim 1, wherein the color signal represents a color of red color, green color, or blue color, for enhancing the color.

12. The video synthesizing device according to claim 11, wherein the synthesizing further comprises:
synthesizing the enhanced video according to the color at least by adding the input video and the enhanced minute color signal.

13. The video synthesizing device according to claim 4, wherein the input video includes video data based on a YIQ signal according to a set of luma information and chrominance information of the video data.

14. The video synthesizing device according to claim 4, wherein the self-addition weighted enhancement time-frequency band-pass filter includes an enhancement rate of zero when a variation amount of the phase signal is at least at a predetermined maximum variation amount to enhance the minute phase change included in the phase change.

15. The video synthesizing device according to claim 4, wherein the phase signal represents a color of red color, green color, or blue color, for enhancing the color.

16. The video synthesizing device according to claim 15, wherein the synthesizing further comprises:
synthesizing the enhanced video according to the phase at least by adding the input video and the enhanced minute phase signal.

17. The video synthesizing method according to claim 6, wherein
the weighted enhanced time-frequency band-pass filter includes an enhanced function A which weights a predetermined enhanced rate a on the basis of a variation amount d of the color signal and a Laplacian of Gaussian (LoG) filter which maximizes a frequency response at a predetermined time frequency f.

18. The video synthesizing method according to claim 17, wherein
the weighted enhancement time-frequency band-pass filter has a window width of 2_{K+1}, k∈[−K, K], a value of the color signal of ¿, a parameter of the Laplacian of Gaussian (LoG) filter of σ, (2ln2)^{1/2}σ_{α}=ε, and F_{2K+1}[·] as a one-dimensional Fourier transform and is defined by the following Expression:
$$[ Math . 20 ]$$
$$A ( d ; ε ) s LoG ( k ; σ ) , \\ s LoG ( k ; σ ) = \frac{LoG ( k ; σ )}{\vert {F}_{2 K + 1} [ LoG ( k ; σ ) ] ( {f}_{t} ) \vert} , \\ A ( d ; ε ) = ( α - 1 ) exp ( - \frac{{d}^{2}}{2 {σ}_{a}^{2}} ) .$$

19. The video synthesizing method according to claim 6, wherein the input video includes video data based on an RGB (Red-Green-Blue) signal.

20. The video synthesizing method according to claim 6, wherein the self-addition weighted enhancement time-frequency band-pass filter includes an enhancement rate of zero when a variation amount of the color signal is at least at a predetermined maximum variation amount to enhance the minute color change included in the color change.

21. The video synthesizing method according to claim 6, wherein the color signal represents a color of red color, green color, or blue color, for enhancing the color.

22. The video synthesizing method according to claim 21, herein the synthesizing further comprises:
synthesizing the enhanced video according to the color at least by adding the input video and the enhanced minute color signal.
